(19) United States
(12) Patent Application Publication
(10) Pub. No.: US 2001/0032326 A1
(43) Pub. Date: Oct. 18, 2001

(54) Recording method and apparatus, transferring method and apparatus, reproducing method and apparatus, and recording medium

(76) Inventor: Naoya Haneda, Tokyo (JP)

Correspondence Address: SONNENSCHEIN NATH & ROSENTHAL, 80th Floor - Sears Tower, 233 S. Wacker Drive, Chicago, IL, 60606, US

(21) Appl. No.: 09/760,550

(22) Filed: Jan. 16, 2001

(30) Foreign Application Priority Data
Jan. 19, 2000 (JP) P2000-014129

(51) Int. Cl. G06F 11/00

(52) U.S. Cl. 714/54

(57) ABSTRACT

The present invention has an objective of enabling efficient data transfer when the transfer unit of data is smaller than the erase unit of the recording medium.

The transfer apparatus 1 receives status information from the recording/reproducing apparatus 2 every time it reads a block length of data integer times the erase unit of the recording medium 203 of the recording/reproducing apparatus 2 from the recording medium 103 and transmits the same. On the other hand, the recording/reproducing apparatus 2 returns status information to the transfer apparatus 1 every time it records a block length of data integer times the erase unit of the recording medium 203.

### BACKGROUND OF INVENTION

1. Field of the Invention

This invention relates to a recording method and apparatus, a transferring method and apparatus, a reproducing method and apparatus and a recording medium suitable for controlling flexibly corresponding to the state or nature of the recording medium used in the recording apparatus while recording data transferred from a transfer apparatus on the recording medium.

2. Description of Related Art

The applicant of the present invention revealed in Japanese Patent Laid Open 1994-131371, Japanese Patent Laid Open 1994-215010 and Japanese Patent Laid Open 1994-301601 an apparatus designed to provide a variety of information by transferring voice, picture, characters, programs and other information from an information distributing apparatus (information transmitter) to a recording apparatus or recording/reproducing apparatus incorporating a semiconductor memory.

FIG. 1 is a schematic perspective view showing the overall appearance of a previous recording/reproducing apparatus proposed by the Japanese patent laid open. This information recording/reproducing apparatus 300A includes a connecting terminal 301 for connecting with an information distributing apparatus not shown, and enables to copy information supplied by the information distributing apparatus through the connecting terminal 301 on a recording medium not shown provided on the information recording/reproducing apparatus 300A. There is no particular limit on the type of recording medium. However, the use of a semiconductor memory advantageous in terms of high-speed copying, easy random accesses and portability is convenient.

This information recording/reproducing apparatus 300A includes a display 302 for displaying characters and pictures and a function selecting apparatus 303 including switch buttons. As this information recording/reproducing apparatus 300A displays the contents of information recorded on the recording medium in a display 302, users can use the function selecting apparatus 303 to choose and reproduce any information desired.

The contents of information supplied by the information providing means include text, voice, image information and computer programs, and this list is not limited. Incidentally, the use of a program means the execution of the program. In this case, however, the user may input information to the program being executed. And when the signals to be reproduced are text or image signals, they may be displayed for example on a display 302 consisting of LCD. In the case of voice information, it may be outputted on a earphone 304. Moreover, although not shown, in place of or in addition to the earphone 304, a speaker may be provided. And an output terminal for signals for reproduction may be provided so that connections may be possible with external displays and speakers.

FIG. 2 is an schematic perspective view showing the overall appearance of another previous information recording/reproducing apparatus proposed in the Japanese patent laid open. The information recording/reproducing apparatus 300B shown in FIG. 2 is a variation of the information recording/reproducing apparatus 300A shown in FIG. 1 in which an information recording apparatus 310 is separated from an information reproducing apparatus 320. This information recording/reproducing apparatus 300B can transfer information outputted by the information recording apparatus 310 to the information reproducing apparatus 320 to reproduce the same by inserting the information recording apparatus 310 to the entry/exit opening 321of the information reproducing apparatus 320.

To reproduce data, the data and control signals must be transferred between the information recording apparatus 310 and the information reproducing apparatus 320. And the information recording apparatus 310 is provided with a connecting terminal 312 for connecting with the information reproducing apparatus 320, and a connecting terminal 312 not shown corresponding to this connecting terminal is provided on the information reproducing unit 320 so that the two connecting terminals may be connected when the information recording apparatus 310 is fitted into the information reproducing unit 320.

The information recording apparatus 310 is provided with two connecting terminals, i.e. a connecting terminal 311 for connection with the information distributing apparatus and another connecting terminal 312 for connection with the information reproducing apparatus 320. However, in place of these two connecting terminals, one connecting terminal may be used by switching the connection.

The information recording apparatus 310 may consist of only a recording medium. Composed of only a recording medium, the whole apparatus will be a more compact and lighter portable information recording device. In this case, reading from and writing into the recording medium will be controlled by the information reproducing apparatus 320 or the information distributing apparatus.

FIG. 3 is a schematic overall view of a prior information distributing apparatus proposed in the Japanese Patent Laid Open. This information distributing apparatus 330 includes a display 331 for displaying the contents and price of information that can be provided and an output selecting means 332 for selecting information desired by the user. The user can copy information by inserting the information recording apparatus 310 shown in FIG. 2 into the entry/exit opening of the information distributing apparatus 330. And by connecting the connecting terminal not shown provided on the information distributing apparatus 330 with the connecting terminal 301 of the information recording/reproducing apparatus 300A shown in FIG. 1 into the entry/exit opening of the information distributing apparatus 330, information can be copied.

The information distributing apparatus 330 includes a recording medium storing information to provide, and an information copy control part (not shown) for reading information desired by the user from this recording medium and for writing the information on the information recording apparatus 310 and the information recording/reproducing apparatus 300A. Another configuration possible, on the other hand, is to connect the information distributing apparatus 330 and the information providing center not shown by a wired or radio communication means and to provide information desired by the user by this communication means. The use of such a configuration removes the need to integrate a recording medium in the information distributing apparatus 30. And even in case where a recording medium is contained in the information distributing apparatus 330, the renewal of information stored in the recording medium through a communication means enables to provide the latest information by containing communication means.

FIG. 4 is an external view of another previous information transfer apparatus proposed in the Japanese patent laid open. This information distributing apparatus 340 disposes the entry opening 341 and the exit opening 342 of the information recording apparatus 310 by separating them by a certain distance. This information distributing apparatus 340 includes a transporting means not shown for carrying the information recording apparatus 310 that had been inserted into the entry port 341, copies the information destined to be provided to the information recording apparatus 310 inserted and discharges the same through the exit opening 342. Those persons wishing to obtain the information can obtain a copy of the information while walking in the direction A shown by the arrow in the drawing. This information providing equipment 340 can quickly provide many persons with information.

As a recording medium used when portability is required for the information recording/reproducing apparatus, the use of nonvolatile memory requiring no battery-based backup of information is convenient because information stored does not vanish. As one of such nonvolatile memory, for example, an EEPROM (Electrically Erasable and Programmable ROM) described in “32M-bit NAND flush memory” by Iwata et al. (Denshi Zairyo, June 1995, pp. 32-37) can be used.

And the applicant of this invention proposed also a means of correct and high-speed recording even on a recording medium with a relatively slow writing speed by providing a plurality of memory chips and buffer memories and writing in parallel in each memory chip data inputted on the time sharing basis in the buffer memories.

And now, the procedure of transferring files from a previous transfer apparatus to a recording/reproducing apparatus and a memory map showing the storing areas in the recording medium 313 of the transfer apparatus and the recording medium 413 of the recording/reproducing apparatus will be explained by referring to FIG. 5.

Here, let's assume that a recording medium 313 contains, for example, four data A-D. Let's assume also that a recording medium 413 contains, for example, two blocks each constituting a erase unit as vacant area (Block 0 and Block 1).

The case of transferring data A, B, C and D from a transfer apparatus to a recording/reproducing apparatus will be explained below.

Every time a transmission of fixed-length data is received from a transfer apparatus, a previous recording/reproducing apparatus writes the data into a recording medium 413 and returns a report on the receiving condition of the data to the transfer apparatus. The transfer apparatus awaits for a reply from the recording/reproducing apparatus, and upon receiving a reply proceeds to the following data transmission.

In other words, in the example shown in FIG. 5, when the transfer apparatus reads data A and sends the same to the recording/reproducing apparatus, the recording/reproducing apparatus having received the data A writes the data A at the top address of the block 0, a vacant area previously chosen. And when the process of writing the data A is completed in good order, the recording/reproducing apparatus returns a “complete” signal as status information to that effect to the transfer apparatus.

Upon receiving a “complete” notice from the recording/reproducing apparatus, the transfer apparatus reads the succeeding data B from the recording medium 313 and transfers the same to the recording/reproducing apparatus. Upon receiving the data B, the recording/reproducing apparatus writes the data B at an address following the data A. When the process of writing the data B is completed in good order, the recording/reproducing apparatus returns a “complete” signal as status information to that effect to the transfer apparatus.

The above process is repeated until all the data that must be transferred are transferred. When data written by the recording/reproducing apparatus have proved to be an error, however, the block to be written is considered as a faulty block, and the data already written in the same block are invalidated. Therefore, the transfer apparatus must repeat from the beginning the whole process of transferring data including those that have already been written in the faulty blocks of the recording/reproducing apparatus, and write data in another vacant area.

In other words, when the transfer apparatus reads data C that follows data B and transmits the same to the recording/reproducing apparatus, the recording/reproducing apparatus having received the data C writes the data C at an address following the data B. If the data C written at this time proves to be an error, however, the recording/reproducing apparatus returns to the transfer apparatus an “error” signal as status information to that effect. In this case, the block 0 is considered as a faulty block and the data A and B that had already been written are invalidated.

Therefore, upon receiving an “error” signal or status information indicating an error from the recording/reproducing apparatus, the transfer apparatus transfers again the data A and B as described above to the recording/reproducing apparatus. When faulty blocks develop, the recording/reproducing apparatus secures other vacant areas as their alternate blocks, and writes successively data transferred from the transfer apparatus into these alternate blocks.

In other words, upon receiving data A transferred again from the transfer apparatus, the recording/reproducing apparatus writes the data A at the top address of the block 1 which is one of the alternate blocks, and upon completely in good order the writing of the data A, the recording/reproducing apparatus returns a “complete” signal as status information to the transfer apparatus.

Thereafter, the transfer apparatus reads in the same way data B, C and D from the recording medium 313 and transfer them successively to the recording/reproducing apparatus. The recording/reproducing apparatus writes successively data B, C and D at the addresses following data A and returns a “complete” signal for each data as status information showing that the process of writing data was completed in good order. In this way, the transfer of data for one block from the transfer apparatus to the recording/reproducing apparatus is completed.

Incidentally, for transferring data from the transfer apparatus to the recording/reproducing apparatus, in addition to actual data that should primarily be transferred, address, data length and other overhead data have so far been bundled together to form a packet for transmission, and the transfer of various overhead data between the transfer apparatus and the recording/reproducing apparatus contributed to preventing the process from becoming more complicated. However, the maximum capacity of actual data contained in a packet depends on the specification of interface among various devices and that of the relevant apparatus. When the maximum capacity of actual data within a packet is smaller than the erase unit, for example, in order to transfer data sufficient to cover an erase unit to the recording medium of the recording/reproducing apparatus, it is necessary to transfer data several times.

According to the previous method, however, it is necessary to return status information from the recording/reproducing apparatus to the transfer apparatus for each transmission of packet to confirm the results of data transfer between the transfer apparatus and the recording/reproducing apparatus. Thus, according to the past method, the process of returning pack status information and other overhead operation not directly related to the processing of actual data in data transfer adversely affected the effective speed of data transfer.

Moreover, as shown in the section on the prior art, the development of any faulty area in the recording medium of the recording/reproducing apparatus invalidates the data that had been properly written in the faulty area and therefore all the operations required to transfer these invalidated data prove to be vain and as a result the effective speed of data transfer is adversely affected.

In view of such a situation, an improvement is desired in the effective speed of data transfer while insuring that data transferred from the transfer apparatus would be written on the recording medium of the recording/reproducing apparatus.

### SUMMARY OF THE INVENTION

It is therefore an object of the present invention to provide a recording method and apparatus, a transferring method and apparatus, a reproducing method and apparatus and a recording medium that enable efficient transfer of data when the transfer unit of data is small than the erase unit of the recording medium.

In one respect, the recording method according to the present invention is a recording method for recording data transferred from a transfer apparatus on a recording medium wherein when the length of recorded data equals integer times of the length of erase unit of the recording medium status information is returned to the transfer apparatus to solve the problem.

In another respect, the recording apparatus according to the present invention is a recording apparatus for recording data transferred by a transfer apparatus on a recording medium, the apparatus comprising a controlling means for returning status information to the transfer apparatus when the length of recorded data equals integer times of the length of erase unit on the recording medium to solve the problem.

In another respect, the transferring method according to the present invention is a transferring method for transferring data to a recording apparatus, wherein when the length of transferred data equals integer times of the length of erase unit of the recording medium on the recording apparatus, status information is received from the recording apparatus to solve the problem.

In another respect, the transfer apparatus according to the present invention is a transfer apparatus for transferring data to a recording apparatus, the apparatus comprising a controlling means for receiving status information from the recording apparatus when the length of data equals integer times of the length of erase unit of the recording medium on the recording apparatus to solve the problem.

In another respect, the recording method according to the present invention is a recording method for recording data transmitted by a transfer apparatus on a recording medium having a plurality of recording media segments, wherein status information is returned to the transfer apparatus when the length of recorded data equals integer times of the length of erase unit on the recording medium on all the recording media segments to solve the problem.

In another respect, the recording apparatus according to the present invention is a recording apparatus for recording data transmitted by a transfer apparatus on a recording medium provided with a plurality of recording media segments, the apparatus comprising a controlling means for returning status information to the transfer apparatus when the length of recorded data equals integer times of the length of erase unit of the recording apparatus on all the recording media segments where data are to be recorded to solve the problem.

In another respect, the reproducing method according to the present invention is a reproducing method for reproducing data recorded on a recording medium, wherein files are controlled by means of the corresponding information at the physical address and logical address of the data recorded and files consisting of data recorded on each record area whose length equals integer times of the length of erase unit of the recording medium are reproduced to solve the problem.

In another respect, the reproducing apparatus according to the present invention is a reproducing apparatus for reproducing data recorded on a recording medium, the apparatus comprising a controlling means for controlling files by corresponding information to the physical address and logical address of data recorded and a reproduction controlling means for reproducing files consisting of data recorded on each recording area whose length equals integer times of the length of erase unit of the recording medium to solve the problem.

In another respect, the recording medium according to the present invention records data composing files in each recording area whose length equals integer times of the length of erase unit of the recording medium, and records control information for identifying data composing files containing the corresponding information to the physical addresses and logical addresses of data recorded to solve the problem.

Moreover, according to the embodiments of the present invention, by confirming the results of writing data transferred by the transfer apparatus to the recording/reproducing apparatus to be written at every transfer of data whose length equals integer times of the length of erase unit, it is possible to reduce the amount of overhead processing than the prior method of confirming the result of writing at every data unit smaller than the erase unit without adversely affecting the reliability of dat at the time of recording and reproduction, and also to enhance the speed and efficiency of data transfer.

### BRIEF DESCRIPTION OF THE DRAWING

FIG. 1 is a schematic perspective view showing the overall appearance of a prior information recording/reproducing apparatus.

FIG. 2 is a schematic perspective view showing the overall appearance of another prior information recording/reproducing apparatus.

FIG. 3 is a schematic perspective view showing the overall appearance of a prior information distributing apparatus.

FIG. 4 is a schematic perspective view showing the overall appearance of another prior information distributing apparatus.

FIG. 5 is a schematic drawing showing the procedure of transferring files between a prior transfer apparatus and recording/reproducing apparatus.

FIG. 6 is a block diagram showing the schematic configuration of a transfer apparatus of the first embodiment according to the present invention.

FIG. 7 is a block diagram showing the schematic configuration of a recording/reproducing apparatus of the first embodiment according to the present invention.

FIG. 8 is a drawing showing an example of recording area in the recording medium in a transfer apparatus of the embodiment of the present invention.

FIG. 9 is a drawing showing an example of file identification information recorded in the recording medium in a transfer apparatus of the embodiment of the present invention.

FIG. 10 is a drawing for explaining the basic procedure of transferring files between the transfer apparatus and the recording/reproducing apparatus according to the present invention.

FIG. 11 is a drawing showing examples of the state of recording areas in the recording medium of the recording/reproducing apparatus used for explaining the file management method in the recording/reproducing apparatus of the embodiment of the present invention.

FIG. 12 is a drawing showing the file management information and the block management information used for explaining the file management method in the recording/reproducing apparatus of the embodiment of the present invention.

FIG. 13 is a flowchart for explaining the procedure for transmitting data in the transfer apparatus of the embodiment of the present invention.

FIG. 14 is a flowchart for explaining the procedure of receiving data in the recording/reproducing apparatus of the embodiment of the present invention.

FIG. 15 is a drawing showing examples of the state of recording areas in a plurality of recording media segments when the recording medium of the recording/reproducing apparatus is composed of such recording media segments.

FIG. 16 is a drawing used for explaining the file management method when the recording medium of the recording/reproducing apparatus is composed of a plurality of recording media segments.

FIG. 17 is a drawing for explaining the concept of memory interleave.

FIG. 18 is a drawing for explaining the procedure of transferring files between a prior transfer apparatus and a similar recording/reproducing apparatus.

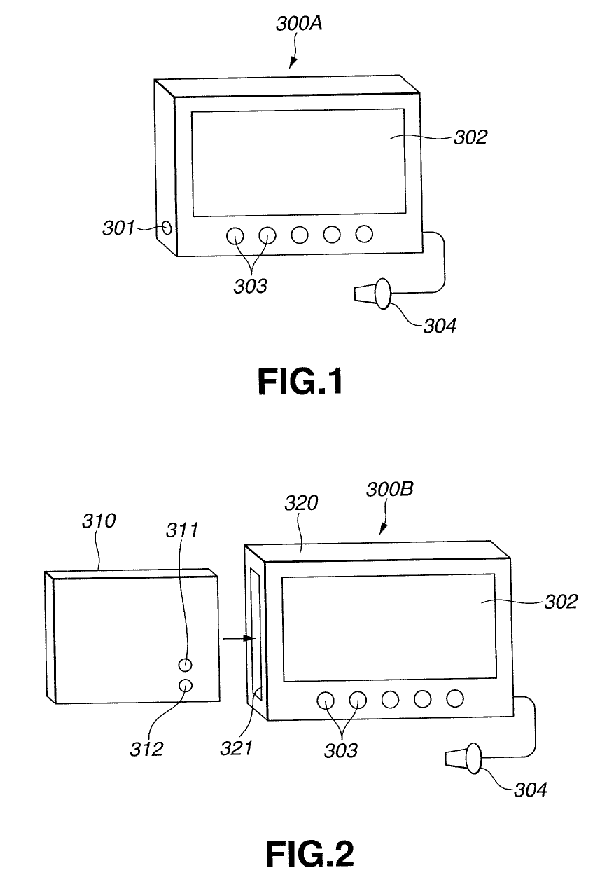

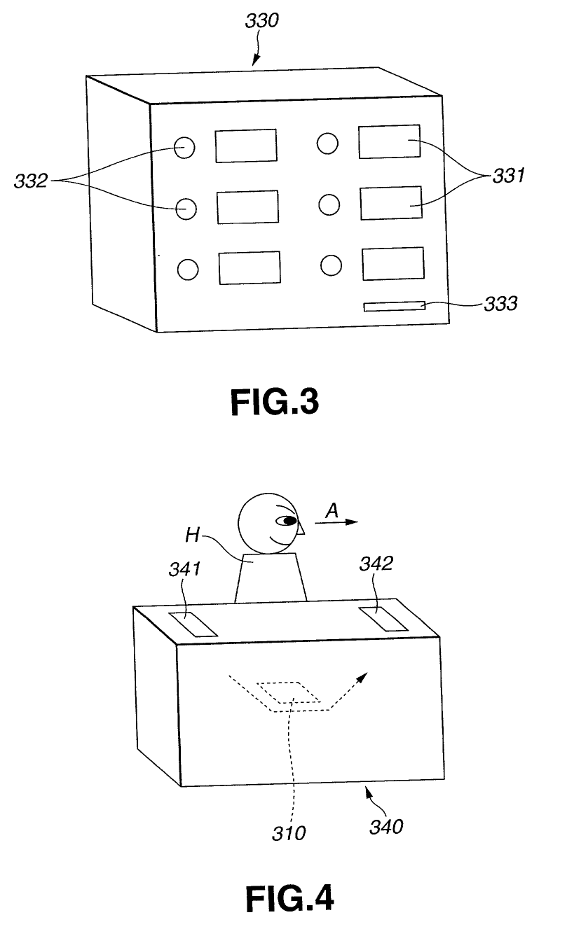

### DESCRIPTION OF PREFERRED EMBODIMENTS

Referring to the drawings, the preferred embodiments according to the present invention will be explained.

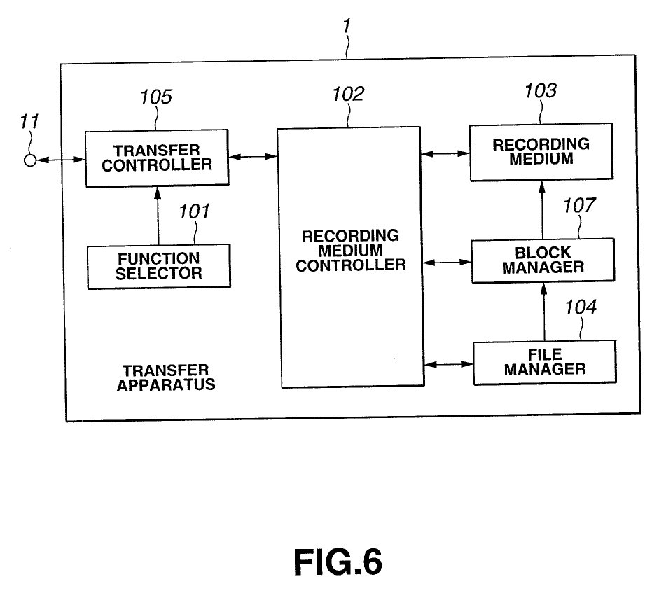

FIG. 6 shows the overall configuration of a transfer apparatus as an embodiment of the transferring method and apparatus according to the present invention.

In FIG. 6, the transfer apparatus 1 includes a function selector 101 that allows the user of the transfer apparatus 1 to select a desired function of write or read and to input accordingly, a recording medium 103 on which a variety of information is recorded as files, a file controller 104 for controlling the files recorded on the recording medium 103, a block controller 107 for controlling the recording condition and effectiveness of data on the recording medium 103, a recording medium controller 102 operating jointly with the file manager 104 and the block manager 107 for controlling the read, write and erase operation of files on the recording medium 103, and a transfer controller 105 for controlling the input of data into the transfer apparatus 1 or the output of data from the transfer apparatus 1 through a terminal 11.

When the function selector 101 is set to write files transferred and inputted from the transfer input/output terminal 11 on the recording medium 103, at first the recording medium controller 102 searches the vacant area on the recording medium 103 through the block controller 107. And as a result of the execution by the transfer controller 105 of a downward transfer protocol as described below to retrieve data inputted and then another execution by the recording medium controller 102 of an upper transfer protocol as described below, the data inputted are written on the recording medium 103 as files. At that time, the recording medium controller 102 records file control information and block control information corresponding to the files written respectively in the file controller 104 and the block controller 107 as described below.

Meanwhile, as the downward transfer protocols, for example, ANSI X3, 131-1984 standards which are commonly called SCSI (Small Computer System Interface), IEEE (Institute of Electrical and Electronic Engineers) 1394 Standard, PCMCIA (Personal Computer Memory Card International Association) PC Card Standard and other standards including physical layers may be used. The adoption of such standardized interfaces enables the transfer apparatus 1 to execute more expansive applications.

And it is desirable that the recording medium controller 102 would be able to control the recording medium 103 without prejudice to the data transfer capacity of the transfer controller 105. In other words, as the data transfer capacity of the whole transfer apparatus 1 is affected by the transfer control capacity (R trans) of the transfer controller 105 or the recording medium control capacity (R prog) of the recording medium controller 102 whichever is lower, an efficient transfer controller or recording medium controller is indispensable. As a file writing method of upper transfer protocol in the recording medium controller 102, a method shown in the specification and drawing of Japanese patent laid open 1993-245751 may be used. This method enables to write files at a high speed on the recording medium 103. In other words, when the recording medium 103 consists of a plurality of recording media segments, the recording medium controller 102 writes data in parallel as follows:

When a recording medium 103 consisting of a plurality of recording media segments is composed of, for example, NAND flush memories described above, in the beginning the memory chip in which data will be written is given a chip select signal and then a command showing a serial data input operation is inputted. Then, an address for writing data is inputted, and data for one page or 512 bytes supplied by the transfer controller 105 are transferred and inputted into the internal register of the memory chip. Finally, when a command showing a write operation is inputted, after the passage of a prescribed time, 512 byte data are transferred from the internal register to be written in the memory cell and the write operation of one page is completed.

Here, the recording medium controller 102 executes successively the input of similar command, address and data on different recording media segments without waiting for the passage of the prescribed time. And when all the data composing one file are fully written, the file controller 104 and the block controller 107 renew the file control information and the block control information.

If the recording medium 103 requires an erase operation for rewriting data, however, useless data are first erased and then a write operation is performed to write new data.

On the other hand, when the function selector 101 is set to read the files recorded in the recording medium 103 and to transfer and output the same to the transfer input/output terminal 11, the user of the transfer apparatus 1 at first refers to a display part (not shown) showing control information based on the file controller 104 and designates the file to be transferred and outputted. Thereupon, the recording medium control part 102 retrieves the control information on the file in question from the file controller 104 and the block controller 107 and identifies the record address and capacity. Then, the recording medium controller 102 executes the upper transfer protocol and reads the data composing the file designated. And as a result of the execution of the downward transfer protocol by the transfer controller 105, the file in question is outputted from the transfer input/output terminal 11.

In this case also, it is desirable that the recording medium controller 102 should be able to control the recording medium 103 without prejudice to the data transfer capacity of the transfer controller 105. And for the upper transfer protocol, data are read in parallel in the same way as the write operation described above as follows.

To begin with, a chip select signal is given to the memory chip designated to read data, and a command showing a read operation is inputted. Then, when an address for reading data is inputted, after a period of time prescribed has passed, data for one page or 512 bytes counting from the memory cell of the address designated are read into the internal register of the memory chip. Finally, with the transfer of the data in question to the transfer controller 105 the read operation of one page is completed.

However, the recording medium controller 102 can read data more rapidly by inputting in parallel similar commands and addresses in different recording media segments without waiting the passage of the prescribed time.

At this point the transfer control block 105 not only controls the input and output of data into or out of the recording medium 103 but can also analyze the information received and identifies the state or demand of the correspondent or on the contrary transmit information showing the state of the transfer apparatus 1 or demand to the correspondent, and executes flexible data transfer according the prescribed communication protocol.

Incidentally, as for the recording medium 103 of the transfer apparatus 1, the use of a semiconductor memory medium or disc medium accessible at random allows to obtain the effect of high-speed information transfer, and in addition the use of a nonvolatile memory eliminates the need of a power source for keeping information and allows further reduction in size of the transfer apparatus 1. As such recording medium 103, for example flush memory and other rewritable nonvolatile memories can be used.

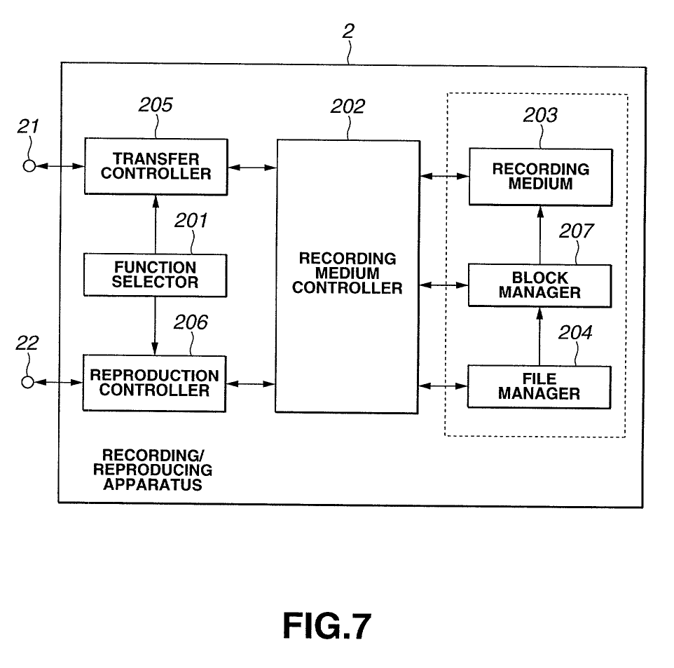

FIG. 7 shows the overall configuration of a recording/reproducing apparatus as an embodiment of the recording method and apparatus and reproducing method and apparatus.

In this FIG. 7, a recording/reproducing apparatus 2 includes a function selector 201 in which the user of the recording/reproducing apparatus 2 selects the desired function of write or read and inputs accordingly, a recording medium 203 in which a variety of information is recorded as files, a file manager 204 for managing files recorded on the recording medium 203, a block manager 207 for managing the recording state and effectiveness of data on the recording medium 203, a recording medium controller 202 operating jointly with the file manager 204 and the block manager 207 for controlling the read, write and erase operation of files on the recording medium 203, a transfer controller 205 for controlling the input of data to the recording/reproducing apparatus 2 and the output of data from the recording/reproducing apparatus 2 through a terminal 21, and a reproduction controller 206 for reproducing the files recorded on the recording medium 203 and for outputting the same to the terminal 22.

When the function selector 201 is set to write the files transferred and inputted from the transfer input/output terminal 21 on a recording medium 203, in the first place the recording medium controller 202 retrieves vacant areas in the recording medium 203 from the block manager 207. And the transfer controller 205 executes the downward transfer protocol as mentioned above and takes in the data inputted, and then the recording medium controller 202 executes the upper transfer protocol as mentioned above to write the data inputted as files on the recording medium 203. At that time, the recording medium controller 202 records the file management information and block management information corresponding to the files written as described below respectively in the file manager 204 and the block manager 207.

On the other hand, when the function selector 201 is set to read the files recorded on the recording medium 203 and transfer and output the same on the transfer input/output terminal 21, in the first place, the user of the recording/reproducing apparatus 2 refers to a display part (not shown) showing management information based on the file manager 204 and designates the files to transfer and output. Thereupon, the recording medium controller 202 retrieves the management information on the files in question from the file manager 204 and the block manager 207 and identifies the record addresses and capacity thereof. Then, the recording medium controller 202 executes the upper transfer protocol to read the data composing the files. And, the transfer controller 205 executes the downward transfer protocol and outputs the files from the transfer input/output terminal 21.

On the other hand, when the function selector 201 is set to read the files recorded on the recording medium 203 and to reproduce and output the same on the reproduction/output terminal 22, in the first place, the user of the recording/reproducing apparatus 2 refers to a display (not shown) showing management information based on the file manager 204 and designates the files to be reproduced and outputted. Thereupon, the recording medium controller 202 retrieves the management information on the files in question from the file manager 204 and the block manager 207 and identifies the record addresses and capacity thereof. Then, in the same way as the transfer output operation described above, the recording medium controller 202 executes the upper transfer protocol to read the data composing the files. Then, the reproduction controller 206 processes for reproduction data read by the recording medium controller 202 and outputs the reproduction data from the reproduction output terminal 22.

Here, the data processing for reproduction depends on the type of information recorded on the recording medium, and if the data are encoded in any way, a decoding process corresponding thereto must be taken. For example, if a file recorded on the recording medium 203 is encoded by an algorithm based on the MPEG (Moving Picture Experts Group) Standard, the reproduction controller 206 decodes the file by means of an algorithm of the same standard.

And the transfer controlling means 205 not only processes data recorded on the recording medium 203 for inputting and outputting but also analyses the information received and identifies the state or demands of the correspondent, or on the contrary it can transmit information showing the condition of the reproducing apparatus 2 or demands for the correspondent. Thus, it is possible to execute flexible data transfer according to the existing communication protocol.

Meanwhile, the recording medium 203, the file manager 204 and the block manager 207 shown in FIG. 7 can be included in a detachable module separate from the recording/reproducing apparatus 2, and in that case, the management information used in the file manager 204 and the block manager 207 can be recorded on the recording medium 203.

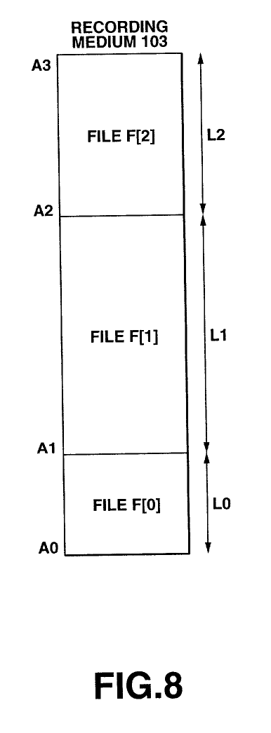

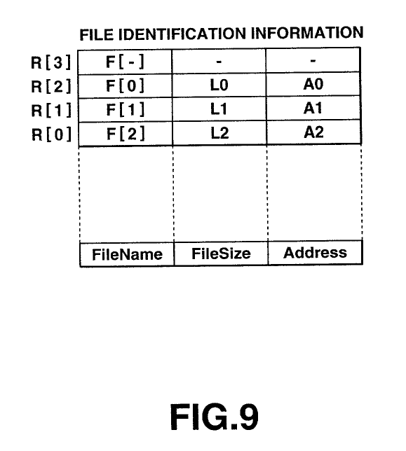

FIG. 8 shows an example of record area in the recording medium 103 in the transfer apparatus 1 according to the present invention, and FIG. 9 shows an example of identification information of files recorded on the recording medium 103.

The recording medium 103 contains record areas for recording files and other various information. And as file identification information, there are file name, file size and address concerning the files recorded on the recording medium. The transfer apparatus 1 has storage areas for file identification information for storing such file identification information.

The embodiment shown in FIG. 8 contain three storage areas shown by Addresses A0 to A3 on the recording medium 103, and FIG. 8 shows an arrangement whereby three files F[0], F[1] and F[2] are recorded in the three record areas shown by these Addresses A0 to A3. And the embodiment shown in FIG. 9 contain three storage areas shown by R[0] to R[3] in the file identification information storage area, and FIG. 9 shows by means of file identification information recorded in recording areas from R[0] to 5R[3] an arrangement whereby files are recorded in the logical order of F[2], F[1] and F[0] on the recording medium 103.

The file identification information provides the following information. File F[2] identified in the first record area R[0] is a file of file size L2 recorded from Address A2, file F[1] identified by the second record area R[1] is a file of file size L1 recorded from Address A1, and file F[0] identified by the third storage area R[2] is a file of file size L0 recorded from Address A0. Here, the inventor will mark the identification information of each file respectively as F[2] [A2:L2], F[1] [A1:L1], and F[0][A0:L0]. And in the fourth storage area R[3] is stored a file identification information indicating that there is no file other than the three mentioned above, and in the drawing this is represented by (−).

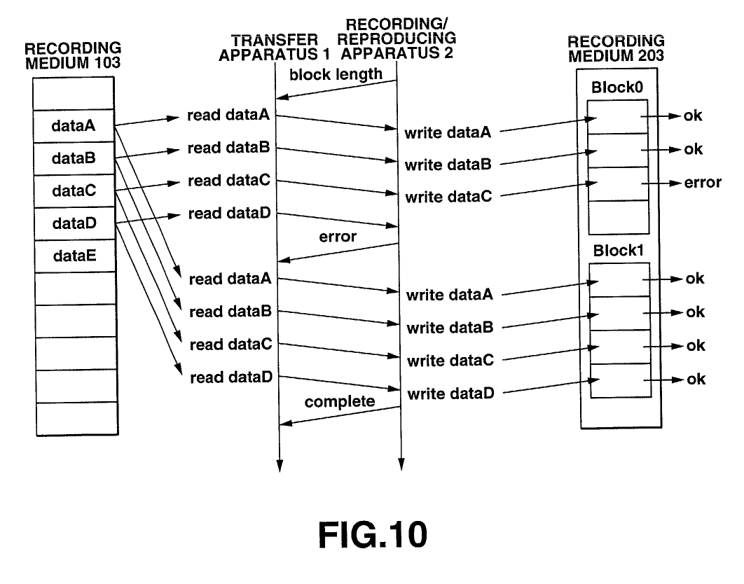

Then, referring to FIG. 10, the procedure of file transfer from the transfer apparatus 1 to the recording/reproducing apparatus 2 according to an embodiment of the present invention, and a memory map showing storage areas in the recording medium 103 of the transfer apparatus 1 and the recording medium 203 of the recording/reproducing apparatus 2 will be explained.

Let's suppose here that the recording medium 103 contains, for example, five data A, B, C, D and E (data A-E), and that also the recording medium 203 contains two blocks (Block 0 and Block 1) each representing an erase unit for vacant area.

And now, the case of transferring data A, B, C, D and E from the transfer apparatus 1 to the recording/reproducing apparatus 2 will be explained below.

Prior to the data transfer, the recording/reproducing apparatus 2 informs the transfer apparatus 1 of the amount of data (referred hereinafter to as “block length”) that will be received before returning a status information. For example, if a block constituting an erase unit of the recording medium 203 consists of four pages and the amount of data transferred by a single data transfer corresponds to one page, the recording/reproducing apparatus 2 informs the transfer apparatus 1 that the block length is four pages.

Then, the transfer apparatus 1 starts transferring data based on the block length received from the recording/reproducing apparatus 2. The recording medium controller 102 reads data A from the recording medium 103 as the top data and transmits the same to the recording/reproducing apparatus 2, and then repeats in the same manner the process of reading the following data and transmitting the same to the recording/reproducing apparatus 2 until the total mount of data reaches the designated block length. In other words, the recording medium controller 102 reads data B from the recording medium 103 and transmits the same to the recording/reproducing apparatus 2, then reads and transmits data C, and then reads and transmits data D.

At this point, when data D have been transmitted, the total block length of data transferred reaches the designated block length of four pages, and the transfer apparatus 1 does not read the following data E and waits for the return of status information from the recording/reproducing apparatus 2.

On the other hand, the recording/reproducing apparatus 2 receives data transferred from the transfer apparatus 1 and write them successively on the recording medium 203 as described above. In other words, the recording/reproducing apparatus 2 having received the first data A that had been transferred from the transfer apparatus 1 writes the data A at the top address of Block 0 or vacant area previously selected. Then, the recording/reproducing apparatus 2 writes data B received successively at an address following the data A, and writes data C received thereafter at an address following the data B.

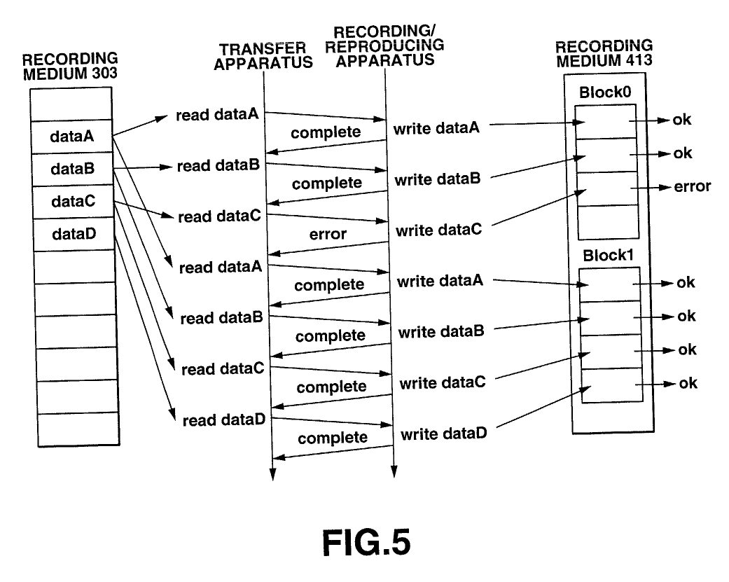

At this point, when the recording/reproducing apparatus 2 writes data C on the recording medium 203 and there developed a write error, unlike the prior method explained in FIG. 5 above, the recording/reproducing apparatus 2 continues to receive data D but does not write the same on the recording medium 203.

And the recording/reproducing apparatus 2, having received a block length of data equivalent to the prescribed block length, returns to the transfer apparatus 1 the result of writing the data received on the recording medium 203. In other words, the recording/reproducing apparatus 2, having received data A, B, C and D equivalent to four pages, recognizes that it had received a block length of data equivalent to the block length, and in view of the fact that the data C proved to be a write error, the recording/reproducing apparatus 2 returns status information of “error” to the transfer apparatus 1. The recording/reproducing apparatus 2 manages the block 0 as a faulty block thereafter, and secures another vacant area, for example Block 1 as an alternate block for the Block 0.

The transfer apparatus 1, upon receiving status information showing “error,” recognizes that the data equivalent to the block length that it had just transferred were not written properly, and starts again reading data A, B, C and D from the recording medium 103 and transmitting them to the recording/reproducing apparatus 2.

The recording/reproducing apparatus 2 keeps on writing successively data transferred again from the transfer apparatus 1 to alternate blocks. In other words, the recording/reproducing apparatus 2, upon receiving data A transferred again from the transfer apparatus 1, writes the data A at the top address of Block 1, an alternate block. After finishing writing normally the data A, it writes data B that it receives then at an address following the data A. And when the data B are written properly, data C that it receives then are written at an address following the data B. And when the data C are written normally, data D that it receives then are written at an address following the data C.

Then, when the data D are written normally, the recording/reproducing apparatus 2 recognizes that it had received data equivalent to four pages or the aforementioned block size, and returns status information of “complete” showing that all the data had been normally written. In this way, data equivalent to one block are transferred from the transfer apparatus 1 to the recording/reproducing apparatus 2.

The transfer apparatus 1 having transmitted data equivalent to four pages or the aforementioned block size, upon receiving status information of “complete,” recognizes that the data equivalent to the aforementioned block size that it had just transmitted have been properly written by the recording/reproducing apparatus 2, and where necessary, keeps on transmitting successively data E and subsequent ones to the recording/reproducing apparatus 2.

The most important characteristic of the embodiment of the present invention is that the process of the transfer apparatus recognizing the result of data transferred to the recording/reproducing apparatus being written normally every time data integer times the erase unit are transferred can reduce the amount of overhead processing as compared with that required for similar recognition for every unit of data smaller than the erase unit. Furthermore, according to the embodiment of the present invention, as the effectiveness of data written is determined by the erase unit, the reliability of data of the recording/reproducing apparatus is not adversely affected by a reduction in the amount of overhead processing. This is another characteristic.

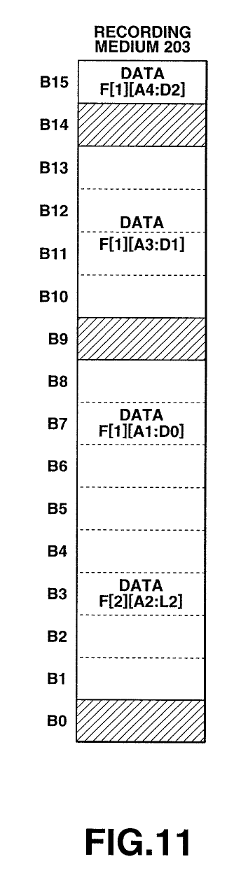

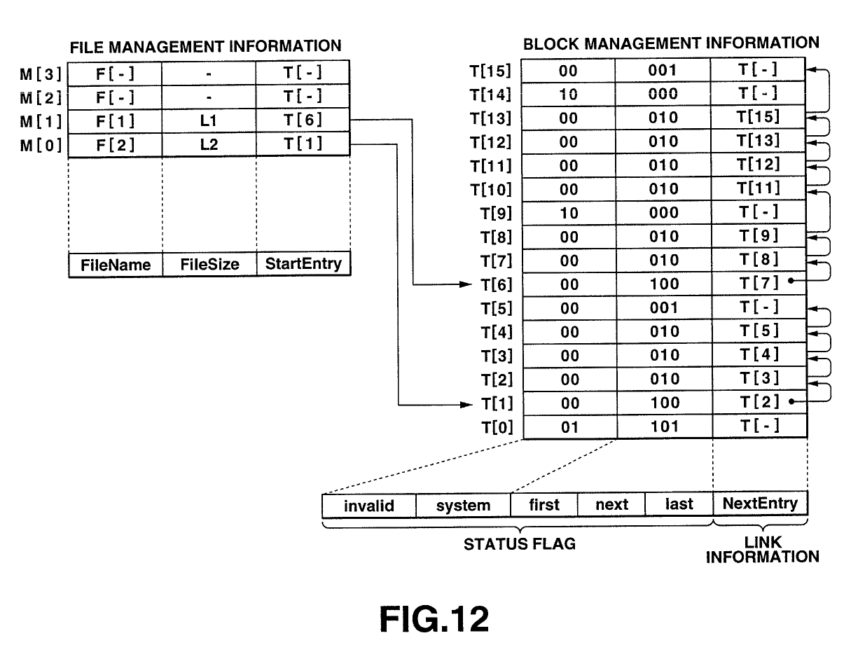

And now, FIG. 11 shows an example of recording medium 203 of the recording/reproducing apparatus 2 of the embodiment of the present invention, and FIG. 12 shows an example of file management information and block management information which are information for managing files recorded on the recording medium 203. Here, the results of transferring files F[2] and F[1] from the transfer apparatus 1 are shown.

The portions marked by oblique lines (blocks B0, B9 and B14) of the recording medium 203 shown in FIG. 11 are blocks created during the manufacture of the recording medium or resulting from excessive rewriting (defective block) or blocks reserved as system areas or spare areas where no files are written (system block).

As shown in FIG. 12, the file manager 204 stores file management information which is management information by the file including file name, file size and the start entry to the block manager 207.

In other words, the file management information shows the following.

Two files are recorded on the recording medium 203, and their logical sequence is file 2 [F], F[1]. The files F[2], F[1] have respectively a block length of L2 and L1, and the top blocks are blocks B1 and B6 corresponding to each of BAT entries T[1], T[6] of the block management information. Here, the value (−) of the file management information shows that it is an invalid piece of file management information.

On the other hand, the block manager 207 has entries respectively corresponding to all the blocks contained in the recording medium 203, and each entry stores block management information or management information by the block such as the status flag or link information of the corresponding block. A table consisting of these entry groups in the block manager 207 is called a BAT (Block Allocation Table) and the individual entries composing the BAT are called BAT entries.

This example shows that the BAT of the block manager 207 has 16 entries. Here, the entry T[0] corresponds to the block B0 of the recording medium 203, and the entry T[1] to the block B1. And similarly the entry T[2] corresponds respectively to the block B2, the entry T[3] to the block B3, the entry T[14] to the block B14, and the entry T[15] to the block B15. In other words, when the block number is n, the entry T[n] of the BAT corresponds to the block Bn.

Status flags recorded in each BAT entry include valid flag indicating that the corresponding block is a space block, invalid flag or system flag showing that it is an aforementioned defective block or a system block, first flag indicating that it is the top block of the file, next flag indicating that it is a middle block of the file, the last flag indicating that it is the last edge of the file, etc.

And link information stored in each BAT entry is a piece of information designed to show the link state of blocks that compose each file. Here, if there is a further block to link, the start entry to BAT entry corresponding to the block is recorded in the entry.

For example, in entry T[1] the start entry to entry T[2] is recorded as link information, in entry T[2] the start entry to entry T[3] is recorded as link information, in entry T[3] the start entry to entry T[4] is recorded as link information, in entry T[4] the start entry to entry Ts[5] is recorded as link information, and in entry T[5] the start entry to entry T[−] is recorded as link information. Accordingly, it will be understood that blocks are linked in the order of B1, B2, B3, B4 and B5. And it will also be understood that these five entries, each carrying a status flag of first, next, next, next and last, constitute a single file.

It will be understood that actually the file is managed as the first (M[0]) file F[2] in the file manager 204. The file F[2] is a file first transferred by the transfer apparatus 1 in the explanation of FIG. 10.

It will be understood in the same way that file F[1] transferred in the second place from the transfer apparatus 1 is recorded as follows. As the file management information shows that the top BAT entry is T[6], it can be judged from the block management information that the group of entries related to the file F[1] are eight BAT entries linked together in the order of the entry T[6] for which the first flag is marked, the entries T[7], T[8], T[10], T[11], T[12], T[13] for which the next flags are marked, and finally the entry T[15] for which the last flag is marked.

Therefore, it will be understood that the file F[1] is composed of the blocks B6, B7, B8, B10, B11, B12, B13 and B15 in the order shown.

If the recording medium 103 of the transfer apparatus 1 of FIG. 6 is similar to the recording medium 203 of the recording/reproducing apparatus 2, the file management information and the block management information in the file manager 104 and the block manager 107 can be materialized in the same way as FIG. 12. In this case, the file identification information of FIG. 9 can be easily computed from the file management information and the block management information. On the other hand, when the recording medium 103 of the transfer apparatus 1 is a sequentially accessed type of recording medium, or one on which files are sequentially recorded, it is possible to omit the block manager 107 by storing the file identification information directly in the file manager 104.

And when the recording medium 203 consists of a plurality of recording media segments, the recording medium controller 202 can efficiently write on a plurality of recording media segments by means of the upper transfer protocol and manage the data recorded on the recording medium by the method that the applicant of the present invention proposed in the specification and drawings of Japanese Patent Laid Open 1999-7408. The method is a method of managing the data recorded on the recording medium by the file and by the block composing such file and reading in parallel data by the parallel block composed of an arbitrary number of blocks.

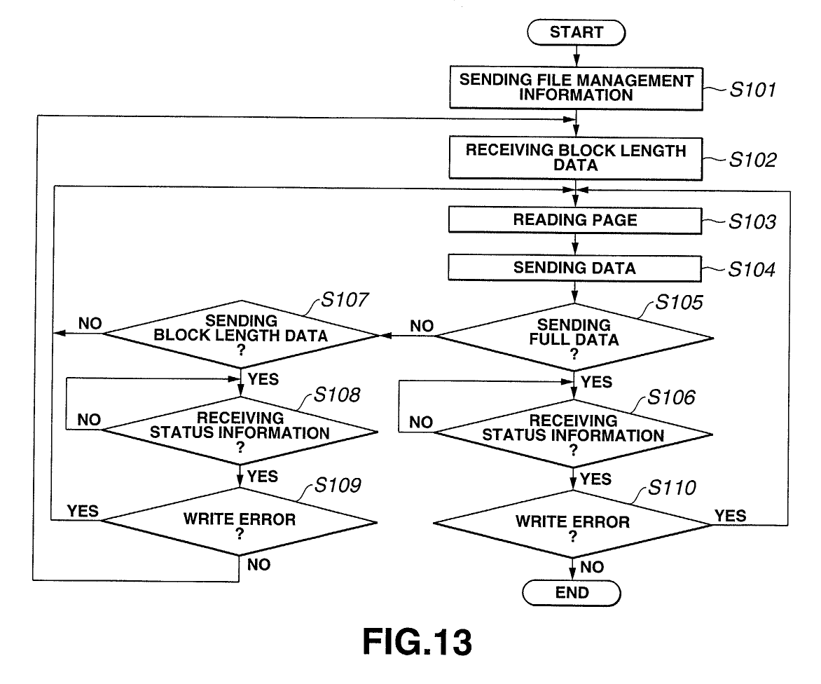

And now, FIG. 13 shows the process of transmitting data in the transfer apparatus of the embodiment of the present invention. Here, the flow of control operation in the transfer apparatus 1 is shown by taking the case of transferring one file from the transfer apparatus 1 to the recording/reproducing apparatus 2.

To begin with, in step S101, before transferring data, the transfer apparatus 1 transmits the management information of the file to be transferred to the recording/reproducing apparatus 2. Here, the file management information includes file name, file size and other similar information.

Then in step S102, the transfer apparatus 1, upon receiving information showing the block length of data from the recording/reproducing apparatus 2, starts transferring data of a block length equivalent to the specified block length. In other words, if the block length of data that can be transferred in one transfer of data is called “transfer unit,” in step S103 the recording medium controller 102 of the transfer apparatus 1 reads data of a transfer unit from the recording medium 103, and in step S104 the transfer controller 105 transmits the data to the recording/reproducing apparatus 2. And the transfer apparatus 1 repeats the steps S103 and S104 until the block length of the data transmitted reaches the prescribed block length (when determined “Yes” in step S107), or until all the dat composing the file are transmitted (when determined “Yes” in step S105.

In step S107, when it is determined that the block length of data transmitted has reached the block length (Yes), the transfer apparatus 1 waits until status information is received from the recording/reproducing apparatus 2, and upon receiving the status information, determines the result of the data transfer that had just been made and recognizes the data to be transferred then.

In other words, in step S109 when it is determined from the status information received in step S108 that a write error has developed in the recording/reproducing apparatus 2 (Yes), the transfer apparatus 1 transfers again the block length data immediately before step S103 and thereafter. On the other hand, when it is determined that the writing was normal (No), the transfer apparatus 1 determines the block length of the data to be transferred then, returns to step S102 and repeats the process. Of course, when the subsequent data transfer is to be made based on the fixed block length, a return to step S103 can reduce the amount of overhead processing.

On the other hand, if in step S105 it is determined that all the data composing a file have been transmitted (Yes), the transfer apparatus 1 waits in the following step S106 for the arrival of status information sent from the recording/reproducing apparatus 2, and upon receiving the status information, determines the result of the immediate previous data transfer from the contents thereof.

In other words, when it is determined from the status information received in step S106 that in step S110 a write error developed in the recording/reproducing apparatus 2 (Yes), the transfer apparatus 1 transfers again data immediately before step S103 and thereafter. When it is determined that the writing was normal (No), on the other hand, the aforementioned process is terminated considering that all the data of the file had been transferred.

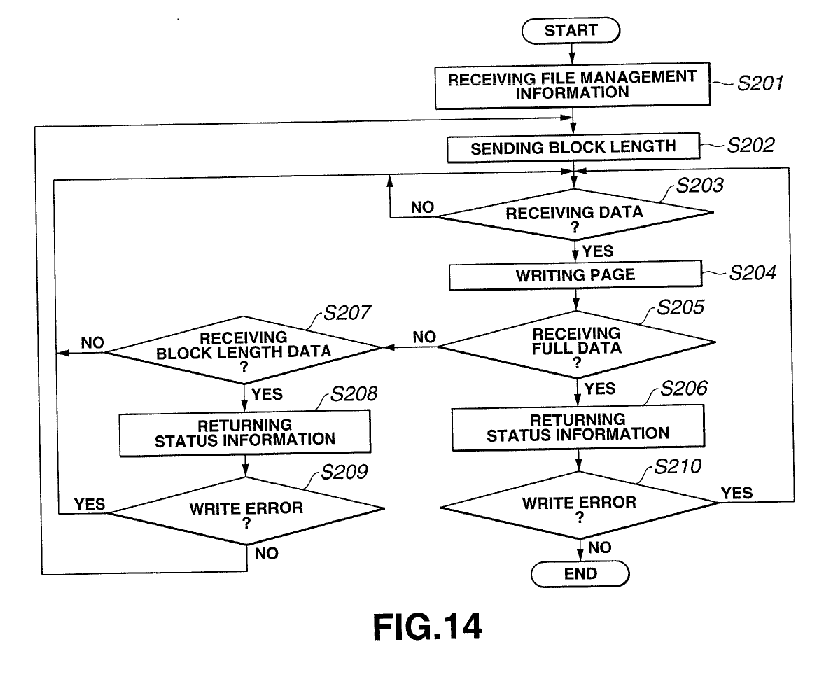

FIG. 14 shows the process of receiving data in the recording/reproducing apparatus 2 according to the embodiment of the present invention.

Here, the flow of control operations in the recording/reproducing apparatus 2 is shown by taking the case of transferring one file from the transfer apparatus 1 to the recording/reproducing apparatus 2.

To begin with, in step S201, before proceeding to a data transfer, the recording/reproducing apparatus 2 receives the management information of the file that will be transferred from the transfer apparatus 1. Here, the file management information contains file name, file size and other pertinent information.

Then, in step S202, the recording/reproducing apparatus 2 transmits to the transfer apparatus 1 information showing the block length. The term “block length” means the block length of data that should be received before transmitting status information to the transfer apparatus 1, and is integer times the erase unit in the recording medium 203.

Then, in step S203, the recording/reproducing apparatus 2 waits until the arrival of data transmitted by the transfer apparatus 1, and when the transfer controller 205 receives the data, in step S204 the recording medium controller 202 writes the data on the recording medium 203. And the recording/reproducing apparatus 2 repeats the steps S203 and S204 until the block length of the data received reaches the required block length (determined “Yes” in step S207), or all the data composing the file have been received (determined “Yes” in step S205).

However, in step S204 upon examination of whether data were written properly at every writing of data and discovery of a write error, as far as the data received are concerned, the recording/reproducing apparatus 2 skips step S204 and refrains from writing data until returning status information to the transfer apparatus 1 in steps S206 or S208 described below.

And when it is determined that in step S207 the block length of the data receive has reached the required block length (Yes), the recording/reproducing apparatus 2 in step S208 returns status information to the transfer apparatus 1.

In other words, if there is any failure to write in the aforementioned step S204, status information of a write error is returned in step S208, and in step S209 the process returns to the aforementioned step S203, where the same data are received to write in a different area of the recording medium 203.

If in step S204 all the writes were successful, in step S208 status information of successful writes is returned and vacant areas for writing the subsequent data are recognized, and in step S209 the process returns to the aforementioned step S202 where the processing will be repeated. Of course, if the subsequent data transfer is made based on the fixed block length, an arrangement to have the process return to step S203 can reduce the amount of overhead processing.

In step S205, on the other hand, if it is determined that all the data composing the file have been received (Yes), the recording/reproducing apparatus 2 returns in the following step S206 status information to the transfer apparatus 1.

In other words, if there was any failure to write data in the aforementioned step S204, in step S206 status information of a write error is returned, and in step S210 the process returns to the aforementioned step S203, where the same data are received to write the same in a different area of the recording medium 203. If in step S204 all the writes were successful, on the other hand, in step S206 status information of successful writes is returned, and the above process is terminated considering that all the data of the file have been completely transferred.

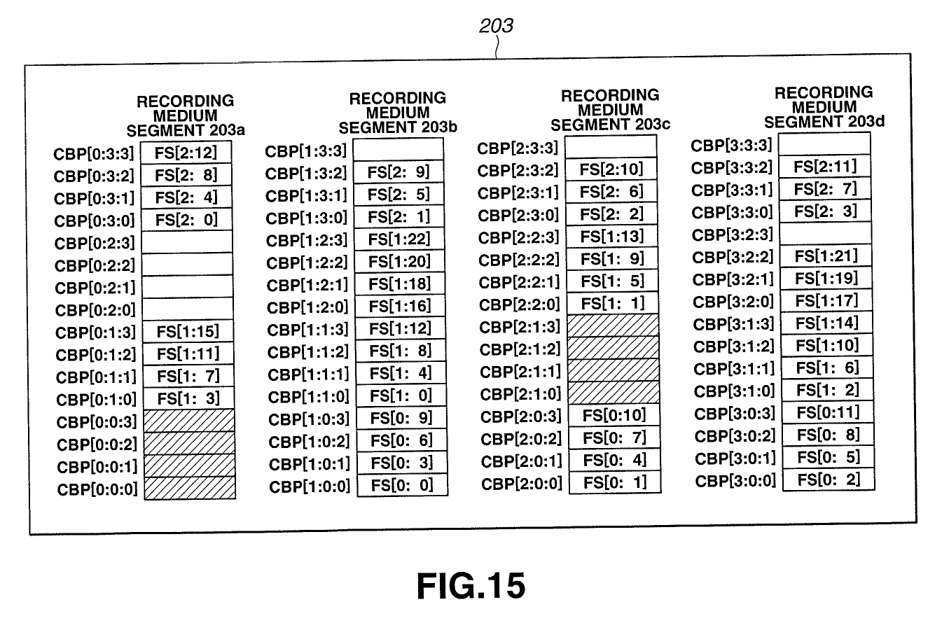

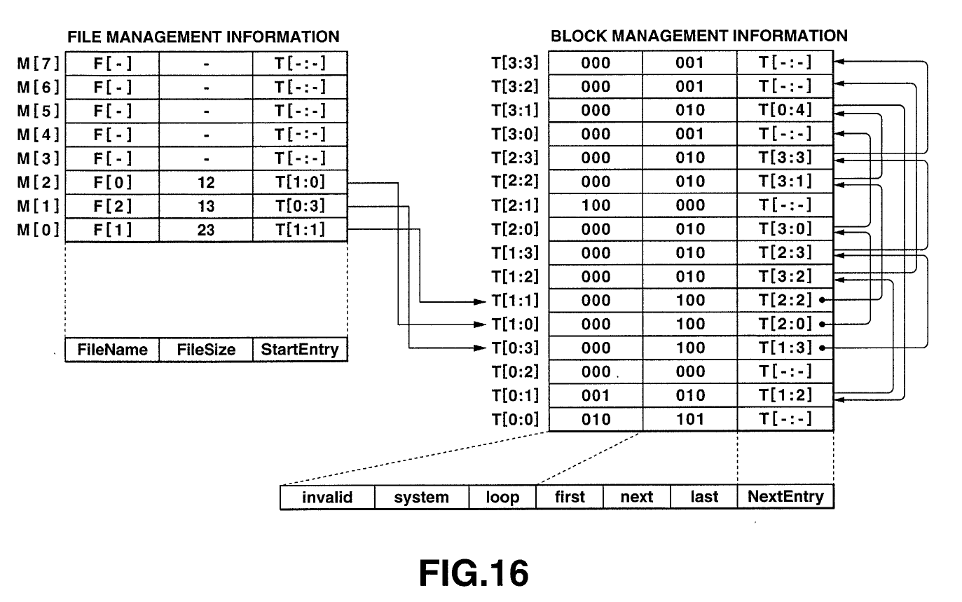

FIG. 15 and FIG. 16 show, as concrete examples, the record state and the management method of files when the recording medium consists of a plurality of recording media segments. Here, an example of recording medium consisting of four recording media segments 203a, 203b, 203c and 203d, and each recording media segment consisting of four pages per block will be explained. The term “block” is an erase unit, and the term “page” means read/write unit of data.

Here, as a method of expressing physical addresses on the recording medium 203, three units of C (chip), B (block) and P (page) will be used. C corresponds to the memory chip number c, B corresponds to the block number b, the smallest unit of erase, and P to the page number p, the smallest unit of read/write, and will be expressed as CBP [c:b:p]. Here, the block length per page will be, for example, 512 bytes as in the case of the block length of a sector. This is designed to facilitate the comparison with the FAT (File Allocation Table) file system.

And as identification method of data to be recorded, two units of F (file) and S (sector) will be used. F corresponds to the file number f, and S corresponds to the sector number s composing a file, and they are expressed as FS[f:s].

In this example, memory chip C[0], C[1], C[2] and C[3] each being recording media segments are composed respectively of four blocks of Block B[0] to B[3], and each block consists of four pages from Page P[0] to P[3].

Incidentally, the portions marked by oblique lines of the recording media segments 203a and 203c show blocks that developed during manufacture or resulting from excessive rewriting of the recording media segments (defective blocks) or blocks reserved for system areas or spare areas in which normally no files are read or written (system blocks).

The file management information shown in FIG. 16 is designed to record the file name, the file size, the start entry to the block management information, etc. of each file recorded on the recording medium 203 at M[0] to M[m−1] and to manage the same and also to manage the logical sequence of each file. Here, m represents the maximum number of files that can be managed by the file manager 204.

In other words, the file management information of FIG. 16 shows the following. The recording medium 203 records three files, the logical sequence of which is files F[1], F[2] and F[0]. These files F[0], F[1] and F[2] have respectively a block length of 12 pages, 23 pages and 13 pages. And the top blocks are, as stated below, blocks CB[1:0], CB [1:1], and CB[0:3] corresponding to each of BAT entries T[1:0], T[1:1], and T[0:3] of the block management information. Here, the invalid value (−) of the file management information shows that this is an invalid file management information.

On the other hand, the block management information contains entries corresponding to each of all the blocks contained in the recording medium 203, and these entries contain management information by the block including the status flag and link information of the blocks corresponding to each entry. In the block management information, as stated above, a table constituted by these entries is called “BAT (Block Allocation Table), and each entry constituting the BAT are called “BAT entries.”

In the example shown in FIG. 15, the recording medium consists of four recording media segments and each recording medium segment consists of four blocks. Therefore, the BAT of the block management information shown in FIG. 16 has 4×4=16 entries. Here, the entry T[0:0] corresponds to the block B[0] of the recording medium segment 203a (memory chip C[0]), and the entry T[0:1] to the block B[1] of the memory chip C[0]. Thereafter in the same manner, the entry T[1:0] corresponds to the block B[0] of the recording medium segment 203b (memory chip C[1]), the entry T[2:0] to the block B[0] of the recording medium segment 203c (memory chip C[2]), the entry T[3:0] to the block B[0] of the recording medium segment 203d (memory chip C[3]), and the entry T[3:3] to the block B[3] of the memory chip C[3]. In other words, the BAT entry T[c:b] corresponds to the block CB [c:b].

The status flags recorded in each BAT entry include, depending on the status of the corresponding block, as stated earlier, invalid flags indicating defective blocks, system flags indicating system blocks, first flag indicating the top block of a file, next flags indicating middle blocks, last flag indicating the last block of a file and loop flags indicating middle blocks and concurrently the last block of a parallel block described below. And blocks without any flag represent vacant areas.

And link information (Next Entry) recorded on each BAT entry is information designed to indicate the link state of blocks constituting a file. Here, if there is any further block to link, a start entry to the BAT entry corresponding to the next block is recorded within the entry.

For example, the entry T[1:0] stores the start entry to the entry T[2:0] as link information, and the entry T[2:0] contains the start entry to the entry T[3:0] as link information. Therefore, it will be understood that the blocks CB[1:0], CB[2:0] and CB [3:0] are linked in the order shown. The fact that these three entries has respectively the aforementioned first flag, next flag and last flag indicates that they constitute a file. As a matter of fact, the file is managed as the third (M[2]) file F[0] in the file management information.

Similarly, it will be understood that the file F[1] is recorded as follows. From the file management information, the top BAT entry of the file F[1] is T[1:1], and BAT entries constituting the file F[1] are, according to the block management information, six BAT entries lead by the entry T[1:1] marked by the first flag, T[2:2], T[3:1], T[0:1] and T[1:2] marked by next flags, and T[3:2] marked by the last flag and linked together in the order shown. Therefore, blocks constituting the file F[1] are blocks corresponding to the aforementioned BAT entries, and are blocks CB[1:1], CB [2:2], CB[3:1], CB[0:1], CB[1:2] and CB[3:2] in the order shown:

And FIG. 15 shows that the data recorded in the blocks are distributed among a plurality of recording media segments 203a, 203b, 203c and 203d. This is a result of writing in parallel data by means of the memory interleave described below. When blocks subjected to such a parallel control are called a parallel block, FIG. 15 shows that the file F[1] consists of two parallel blocks: the first parallel block composed of four blocks CB[1:1], CB[2:2], CB[3:1] and CB[0:1], and the second parallel block composed of two blocks CB[1:2] and CB[3:2].

In the block management information, in order to show that the file F[1] is composed of two parallel blocks, the BAT entry T[0:1] corresponding to the last block CB[0:1] in the first parallel block contains a loop flag as a status flag. And the fact that BAT entry T[3:2] carries a last flag as a status flag indicates that it is the last block within the second parallel block and also the last block of the file F[1]. In other words, the last flag has the same meaning as a loop flag and at the same time it means that it is the last block in the file.

The most important advantage of the aforementioned parallel block is that, in case a recording medium of which the program time for writing data is relatively longer than the data input time is used, the execution of an memory interleaving that enables to record data in a plurality of recording media segments enables to rewrite data at a high speed. As a such recording medium, there is a NAND-type EEPROM described above, and there are memories of which the program time t prog from an internal register to a memory cell requires about ten times the input time [t input] of data into an internal register.

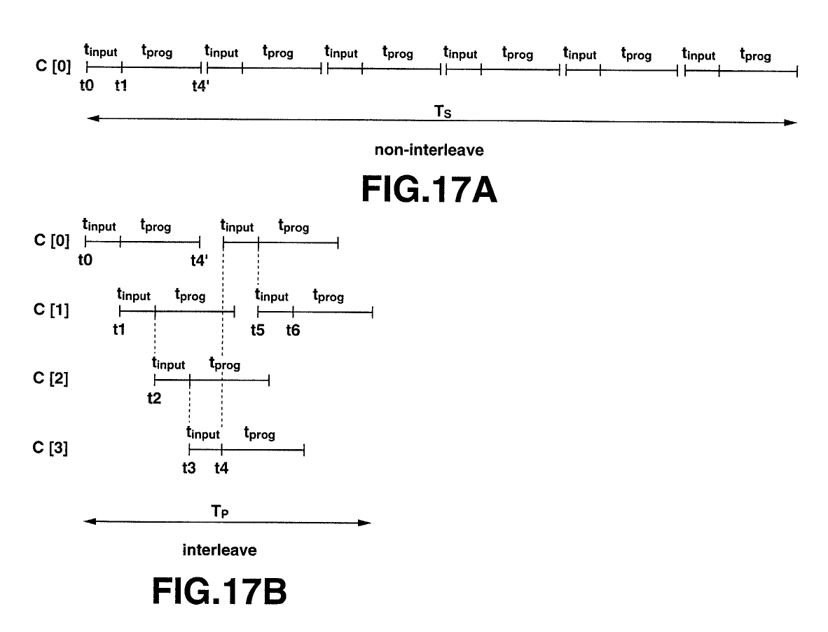

The concept of interleaving will be explained below by referring to FIG. 17. Here, the mode of writing data equivalent to six pages in a recording medium is shown. As shown in FIG. 17(a), if no interleaving is put into force, only memory chip C[0] which is a recording medium segment is used for successive writing, and therefore a write time Ts of (t input+t prog)×6 is required. In case interleaving is put into force, on the other hand, as shown in FIG. 17(b), data are interleaved on four recording media segments or memory chips C[0], C[1], C[2] and C[3]. Therefore, the write time is reduced to a write time Tp (t input×6)+t prog.

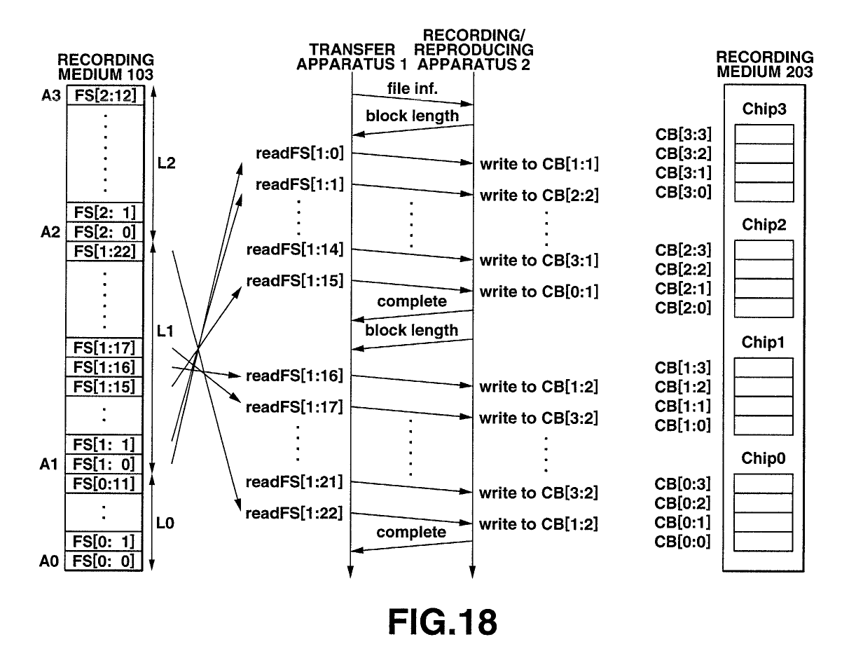

And now, referring to FIG. 18, the file transfer procedure from the transfer apparatus 1 to the recording/reproducing apparatus 2 of the embodiment of the present invention and the memory map showing storage areas in the recording medium 103 of the transfer apparatus 1 and the recording medium 203 of the recording/reproducing apparatus 2 in case where the recording/reproducing apparatus 2 includes a plurality of recording media segments 203a-203d shown in FIG. 15 as the recording medium 203 will be explained.

FIG. 18 showing the recording medium 103 of the transfer apparatus 1 is a more concrete expression of the recording medium 103 shown in the previous FIG. 10, and shows the data of each file by the sector. In other words, the file F[0] is composed of data contained in 12 sectors from the sector FS[0:0] to FS[0:11] recorded from the address A0 to immediately before A1, the file F[1] is composed of data contained in 23 sectors from the sector FS[1:0] to FS[1:22] recorded from the address A1 to immediately before A2 and the file F[2] is composed of data contained in 13 sectors from the sector FS[2:0] to FS[2:12] recorded from the address A2 to A3.

And the recording medium 203 of the recording/reproducing apparatus 2 is a simplified expression of four recording media segments shown in FIG. 15, and the recording media segments 203a to 203d respectively correspond to the memory chips 0 to 3, and shows the storage area of each chip by the block.

And now the case of transferring a file F[1] recorded on the recording medium 103 of the transfer apparatus 1 to the recording medium 203 of the recording/reproducing apparatus 2 will be explained as follows:

To begin with, the transfer apparatus 1 transmits the management information of the files to transfer (file inf.) to the recording/reproducing apparatus 2, and the recording/reproducing apparatus 2, having secured the vacant areas for recording the files in the recording medium 203, informs the transfer apparatus 1 of the block length of the data to receive before returning status information thereto.

In this example, as vacant areas for writing the file F[1], the block CB[1:1], CB [2:2], CB[3:1], CB[0:1], CB[1:2] and CB[3:2] are secured, and four blocks CB[1:1], CB[2:2], CB[3:1], CB[0:1] and two blocks CB[1:2] and CB[3:2] are interleaved so that data may be written there.

Therefore, the recording/reproducing apparatus 2, after having provided the transfer apparatus 1 with information indicating four blocks as the block length of data, receives data for four blocks, write the same on the recording medium 203 and returns status information to the transfer apparatus 1. After successfully transferring data of the block length, the recording/reproducing apparatus 2 sends information indicating that the block lengths is two blocks to the transfer apparatus 1, receives data for two blocks and writes the same on the recording medium 203, and returns status information to the transfer apparatus 1. When the data following the top four blocks of the file F[1] are less than two blocks, however, after writing the last data of the file F[1] in the recording medium 203, the recording/reproducing apparatus 2 returns status information to the transfer apparatus 1.

On receiving block length information from the recording/reproducing apparatus 2, the transfer apparatus 1 repeats the process of reading data from the recording medium 103 and transmitting the same to the recording/reproducing apparatus 2, and when the data transmitted reach the block length, the transfer apparatus 1 waits for the return of status information from the recording/reproducing apparatus 2. In other words, when a block which is the erase unit of the recording medium 203 consists of four pages, and the block length is four blocks, the transfer apparatus 1 transmits consecutively data contained in the top 16 (=4×4) pages of the file F[1] or the sectors FS[1:0] to FS[15] to the recording/reproducing apparatus 2 and then receives status information from the recording/reproducing apparatus 2.

If the status information received indicates a write error in the recording/reproducing apparatus 2, the transfer apparatus 1 transfers again the top 16 pages of data of the file F[1] to the recording/reproducing apparatus 2 and repeats the transfer process until it receives status information indicating successful writing (complete). And when the status information shows a successful writing (complete), before proceeding to the transmission of the remaining data of the file F[1], it receives information showing a new block length from the recording/reproducing apparatus 2.

In other words, when the block length is two blocks as described above, the transfer apparatus 1, after having consecutively transmitted eight (=4×4) pages of data to the recording/reproducing apparatus 2, receives status information from the recording/reproducing apparatus 2. In reality, however, as the block length of the file F[1] is 23 pages, the sectors FS[1:16] to FS[1:22] containing data of 7 pages or the balance after subtracting 16 pages of data that had already been transmitted are transferred to the recording/reproducing apparatus 2.

If status information received indicates a write error in the recording/reproducing apparatus, the transfer apparatus 1 transfers again the data contained in the 7-page latter half of the file F[1] to the recording/reproducing apparatus 2, and repeats the process until the status information it receives indicates a successful write (complete). And when the status information indicates a successful write (complete), the processing is terminated considering that all the data of the file F[1] have been transmitted.

The recording/reproducing apparatus 2 writes data contained in the top 16 pages of the file F[1] it had received by interleaving the recording medium 203 in four blocks of CB [1:1], CB[2:2], CB[3:1] and CB[0:1] selected when the block length was decided. And if any anomaly develops at the time of writing data of these four blocks, the recording/reproducing apparatus 2 returns status information indicating a write error to the transfer apparatus 1, and then secures further vacant areas for four blocks in preparation for writing the same data that may be transferred again from the transfer apparatus.

Here, the four blocks in which a write error or write errors occurred are considered provisionally as faulty blocks. After all the data of the file F[1] have been transferred, however, it is possible to detect blocks which are not faulty blocks within the four blocks by checking data read/write in the four blocks in the recording/reproducing apparatus and to secure them again as vacant areas by managing them as normal blocks.

On the other hand, upon obtaining a success in writing data of the four blocks, the recording/reproducing apparatus 2 returns status information indicating normal write (complete) to the transfer apparatus 1, and in order to receive data following the top four blocks of the file F[1], the recording/reproducing apparatus 2 provides the transfer apparatus 1 with information indicating the two blocks as a new block length.

Then, the recording/reproducing apparatus 2 writes the data contained in the 7-page latter half of the file F[1] received by interleaving the recording medium 203 in two blocks of CB[1:2] and CB[3:2] selected in the process of deciding the block length. And if any anomaly develops at the time of writing data for these two blocks, the recording/reproducing apparatus 2 returns status information indicating a write error to the transfer apparatus 1, and then in preparation for writing the same data transferred again from the transfer apparatus 1 secure the vacant areas for two blocks. On the other hand, upon obtaining a success in writing data for the two blocks, the recording/reproducing apparatus 2 returns status information showing normal writes (complete) to the transfer apparatus 1, and terminates the processing considering that all the data of the file F[1] have been received.

As described above, according to the embodiments of the present invention, by confirming the results of writing data transferred by the transfer apparatus to the recording/reproducing apparatus at every transfer of data integer times the erase unit, it is possible to reduce the amount of overhead processing than by confirming such results at every data unit smaller than the erase unit. In addition, according to the embodiments of the present invention, in view of the fact that the effectiveness of data written is determined by the erase unit, the reliability of data of the recording/reproducing apparatus is not adversely affected by any reduction in the amount of overhead processing.

What is claimed is:

1. A recording method for recording data transferred from a transfer apparatus on a recording medium wherein
when the length of recorded data equals integer times of the length of erase unit of the recording medium, status information is returned to the transfer apparatus.

2. The recording method according to claim 1 wherein said status information includes information showing the control result of data writing in said recording medium.

3. The recording method according to claim 2 wherein recording areas where a write error or write errors occurred are managed as faulty areas when said status information indicates such write error or write errors.

4. The recording method according to claim 3 wherein
when said faulty areas consists of a plurality of erase units, a plurality of erase units are individually checked and erase units where data can be recorded normally are again managed as vacant areas.

5. The recording method according to claim 2 wherein alternate areas for recording areas where a write error or write errors occurred are selected anew when said status information indicates such write error or write errors.

6. The recording method according to claim 1 wherein the block length of data to be received until said status information is returned is notified in advance to said transfer apparatus.

7. The recording method according to claim 1 wherein semiconductor memories are used as said recording medium.

8. The recording method according to claim 1 wherein a magneto-optic disc or a magnetic disc is used as said recording medium.

9. A recording apparatus for recording data transferred by a transfer apparatus on a recording medium, the apparatus comprising:
a controlling means for returning status information to the transfer apparatus when the length of recorded data equals integer times of the length of erase unit of the recording medium.

10. The recording apparatus according to claim 9 wherein said status information includes the control result of data writing in said recording medium.

11. The recording apparatus according to claim 10 wherein recording areas where a write error or write errors occurred are managed as faulty areas when said status information indicates such write error or write errors.

12. The recording apparatus according to claim 11 wherein
when said faulty areas consists of a plurality of erase units, a plurality of erase units are individually checked and erase units where data can be recorded normally are again managed as vacant areas.

13. The recording apparatus according to claim 10 wherein alternate areas for recording areas where a write error or write errors occurred are selected anew when said status information indicates such write error or write errors.

14. The recording apparatus according to claim 9 wherein the block length of data to be received until said status information is returned is notified in advance to said transfer apparatus.

15. The recording apparatus according to claim 9 wherein semiconductor memories are used as said recording medium.

16. The recording apparatus according to claim 9 wherein a magneto-optic disc or a magnetic disc is used as said recording medium.

17. A transferring method for transferring data to a recording apparatus wherein
when the length of transferred data equals integer times of the length of erase unit of the recording medium on the recording apparatus, status information is received from the recording apparatus.

18. The transferring method according to claim 17 wherein said status information includes the control result of data writing in said recording medium in said recording apparatus.

19. The transferring method according to claim 18 wherein data transmitted are again transmitted until the immediately previous status information is received when said status information indicates a write error or write errors in said recording medium.

20. The transferring method according to claim 17 wherein the block length of data to be received until said status information is returned is received in advance from said transfer apparatus.

21. A transfer apparatus for transferring data to a recording apparatus, the apparatus comprising:
a controlling means for receiving status information from the recording apparatus when the length of transferred data equals integer times of the length of erase unit of the recording medium on the recording apparatus.

22. The transfer apparatus according to claim 21 wherein said status information includes the control result of data writing in said recording medium in said recording apparatus.

23. The transfer apparatus according to claim 22 wherein data transmitted are again transmitted until the immediately previous status information is received when said status information indicates a write error or write errors in said recording medium.

24. The transfer apparatus according to claim 21 wherein the block length of data to be received until said status information is returned is received in advance from said transfer apparatus.

25. A recording method of recording data transferred by a transfer apparatus on a recording medium having a plurality of recording media segments wherein
status information is returned to the transfer apparatus when the length of recorded data equals integer times of the length of erase unit of the recording medium on all the recording media segments.

26. The recording method according to claim 25 wherein said status information includes the control result of data writing in said recording medium.

27. The recording method according to claim 26 wherein recording areas where a write error or write errors occurred are managed as faulty areas when said status information indicates such write error or write errors.

28. The recording method according to claim 27 wherein a plurality of erase units are individually checked and erase units where data can be recorded normally are again managed as vacant areas when said faulty areas consists of a plurality of erase units.

29. The recording method according to claim 26 wherein alternate areas for recording areas where a write error or write errors occurred are selected anew when said status information indicates such write error or write errors.

30. The recording method according to claim 25 wherein the block length of data to be received until said status information is returned is notified in advance to said transfer apparatus.

31. The recording method according to claim 25 wherein semiconductor memories are used as said recording medium.

32. The recording method according to claim 25 wherein a magneto-optic disc or a magnetic disc is used as said recording medium.

33. A recording apparatus for recording data transferred by a transfer apparatus on a recording medium provided with a plurality of recording media segments, the apparatus comprising:
a controlling means for returning status information to the transfer apparatus when the length of recorded data equals integer times of the length of erase unit of the recording apparatus on all the recording media segments where data are to be recorded.

34. The recording apparatus according to claim 33 wherein said status information includes the control result of data writing in said recording medium.

35. The recording apparatus according to claim 34 wherein recording areas where a write error or write errors occurred are managed as faulty areas when said status information indicates such write error or write errors.

36. The recording apparatus according to claim 35 wherein a plurality of erase units are individually checked and erase units where data can be recorded normally are again managed as vacant areas when said faulty areas consists of a plurality of erase units.

37. The recording apparatus according to claim 34 wherein alternate areas for recording areas where a write error or write errors occurred are selected anew when said status information indicates such write error or write errors.

38. The recording apparatus according to claim 33 wherein the block length of data to be received until said status information is returned is notified in advance to said transfer apparatus.

39. The recording apparatus according to claim 33 wherein semiconductor memories are used as said recording medium.

40. The recording apparatus according to claim 33 wherein a magneto-optic disc or a magnetic disc is used as said recording medium.

41. A reproducing method for reproducing data recorded on a recording medium wherein
files are controlled by means of the corresponding information at the physical address and logical address of data recorded; and
files consisting of data recorded on each record area whose length equals integer times of the length of erase unit of the recording medium are reproduced.

42. A reproducing apparatus for reproducing data recorded on a recording medium, the apparatus comprising:
a controlling means for controlling files by corresponding information to the physical addressed and logical addresses of data recorded; and
a reproduction controlling means for reproducing files consisting of data recorded on each recording area whose length equals integer times of the length of erase unit of the recording medium.

43. A recording medium wherein
data composing files in each recording area whose length equals integer times of the length of erase unit of the recording medium are recorded, and
records control information for identifying data composing files containing the corresponding information to the physical addresses and logical addresses of data recorded are recorded.
